(19) United States
(12) Patent Application Publication
(10) Pub. No.: US 2025/0182776 A1
(43) Pub. Date: Jun. 5, 2025

(54) METHOD FOR GENERATING A FEATURE ENCODING MODEL, METHOD FOR AUDIO DETERMINATION, AND A RELATED APPARATUS

(71) Applicant: Beijing Youzhuju Network Technology Co., Ltd., Beijing (CN)

(72) Inventors: Xingjian DU, Beijing (CN); Zijie WANG, Beijing (CN); Zhesong YU, Beijing (CN); Bilei ZHU, Beijing (CN); Zejun MA, Beijing (CN)

(21) Appl. No.: 18/729,140

(22) PCT Filed: Jan. 6, 2023
(86) PCT No.: PCT/CN2023/070800

§ 371 Date: Jul. 15, 2024

(30) Foreign Application Priority Data
Jan. 14, 2022 (CN) 202210045047.4

(51) Int. Cl. G10L 25/51

(52) U.S. Cl. CPC G10L 25/51

(57) ABSTRACT

The disclosure relates to a method for generating a feature encoding model. The method includes: acquiring a plurality of sample audios marked with category labels; extracting audio features of the plurality of sample audios; encoding the audio features of the plurality of sample audios by the feature encoding model to obtain a plurality of encoding vectors of the plurality of sample audios, and performing classification processing on the plurality of sample audios based on the plurality of encoding vectors to obtain category prediction values of the plurality of sample audios; and determining a target loss value of a target loss function based on the plurality of encoding vectors, the category prediction values of the plurality of sample audios and the category labels of the plurality of sample audios, and updating a parameter of the feature encoding model based on the target loss value-se as to obtain the trained feature encoding model.

### CROSS-REFERENCE TO RELATED APPLICATION

This is a national stage application based on International Patent Application No. PCT/CN2023/070800, filed Jan. 6, 2023, which claims priority to Chinese Patent Application No. 202210045047.4, filed on Jan. 14, 2022 and entitled “METHOD FOR GENERATING A FEATURE ENCODING MODEL, METHOD FOR AUDIO DETERMINATION, AND A RELATED APPARATUS”, the disclosures of which are incorporated herein by reference in their entireties.

### FIELD

The present disclosure relates to the technical field of artificial intelligence, and in particular to a method for generating a feature encoding model, a method for audio determination, and a related apparatus.

### BACKGROUND

A piece of musical composition usually contains a rich variety of elements, such as rhythm, melody, and harmony, presenting a multi-level internal structure. Therefore, a cover of the musical composition can introduce very rich variations, making the musical composition change in a number of aspects such as tune, timbre, tempo, structure, melody, and lyrics. In the related art, it is possible to determine whether audios are the same audio according to feature vectors of the audios, and then to complete the task of cover retrieval. However, due to the variety of changes in the audios, it is very difficult to determine whether the audios are the same audio. Therefore, how to improve the identifiability of the feature vectors of the audios is an urgent technical problem to be solved.

### SUMMARY

This section is provided to present, in a brief form, ideas which will be described in detail in the following DETAILED DESCRIPTION. This section is not intended to identify key features or essential features of the claimed technical solution, nor is it intended to limit the scope of the claimed technical solution.

In a first aspect, the present disclosure provides a method for generating a feature encoding model, comprising:
acquiring a plurality of sample audios marked with category labels;
extracting audio features of the plurality of sample audios;
encoding the audio features of the plurality of sample audios by the feature encoding model to obtain a plurality of encoding vectors of the plurality of sample audios, and performing classification processing on the plurality of sample audios based on the plurality of encoding vectors to obtain category prediction values of the plurality of sample audios; and
determining a target loss value of a target loss function based on the plurality of encoding vectors, the category prediction values of the plurality of sample audios and the category labels of the plurality of sample audios, and updating a parameter of the feature encoding model based on the target loss value to reduce a difference between the encoding vectors of the sample audios of the same category, to increase a difference between the encoding vectors of the sample audios of different categories, and to reduce a difference between the category prediction values and the category labels of the plurality of sample audios, so as to obtain the trained feature encoding model.

In a second aspect, the present disclosure provides a method for audio determination, comprising:
acquiring an audio to be queried;
extracting an audio feature of the audio to be queried;
processing, according to a trained feature encoding model, the audio feature of the audio to be queried to obtain a first feature vector of the audio to be queried; and
determining, based on a similarity between the first feature vector and second feature vectors of a plurality of candidate audios in a reference feature library, a target candidate audio, being the same audio as the audio to be queried, from the reference feature library, the second feature vectors of the plurality of candidate audios being predetermined by the trained feature encoding model;
wherein the feature encoding model is obtained by the method for generating a feature coding model according to the first aspect.

In a third aspect, the present disclosure provides an apparatus for training a feature encoding model, comprising:
a first acquiring module configured to acquire a plurality of sample audios marked with category labels;
a first extraction module configured to extract audio features of the plurality of sample audios;
an encoding and classifying module configured to encode the audio features of the plurality of sample audios by the feature encoding model to obtain a plurality of encoding vectors of the plurality of sample audios, and performing classification processing on the plurality of sample audios based on the plurality of encoding vectors to obtain category prediction values of the plurality of sample audios; and
a first determination module configured to determine a target loss value of a target loss function based on the plurality of encoding vectors, the category prediction values of the plurality of sample audios and the category labels of the plurality of sample audios, and updating a parameter of the feature encoding model based on the target loss value to reduce a difference between the encoding vectors of the sample audios of the same category, to increase a difference between the encoding vectors of the sample audios of different categories, and to reduce a difference between the category prediction values and the category labels of the plurality of sample audios, so as to obtain the trained feature encoding model.

In a fourth aspect, the present disclosure provides an apparatus for audio determination, comprising:
a second acquiring module configured to acquire an audio to be queried;
a second extraction module configured to extract an audio feature of the audio to be queried;
a processing module configured to process, according to a trained feature encoding model, the audio to be queried to obtain a first feature vector of the audio to be queried; and
a second determination module configured to determine, based on a similarity between the first feature vector and second feature vectors of a plurality of candidate audios in a reference feature library, a target candidate audio, being the same audio as the audio to be queried, from the reference feature library, the second feature vectors of the plurality of candidate audios being predetermined by the trained feature encoding model;
wherein the feature encoding model is obtained by the method for generating a feature coding model according to the first aspect.

In a fifth aspect, the present disclosure provides a computer-readable medium storing a computer program thereon, wherein the program, when executed by a processing device, implements the steps of the method described in the first and second aspects.

In a sixth aspect, the present disclosure provides an electronic device, comprising:
a storage device storing at least one computer program thereon; and
at least one processing device being used to execute the at least one computer program in the storage device to implement the steps of the method described in the first and second aspects.

Other features and advantages of the present disclosure will be described in detail in the following DETAILED DESCRIPTION.

### BRIEF DESCRIPTION OF THE SEVERAL VIEWS OF THE DRAWINGS

The above and other features, advantages, and aspects of embodiments of the present disclosure will become more apparent with reference to the accompanying drawings and the following specific embodiments. The same reference signs represent the same or similar elements throughout the drawings. It should be understood that the accompanying drawings are merely schematic, and the components or elements are not necessarily drawn to scale. In the drawings:

FIG. 1 is a flowchart of a method for generating a feature encoding model according to an example embodiment of the present disclosure;

FIG. 2 is a flowchart showing determining of a target loss value of a target loss function according to an example embodiment of the present disclosure;

FIG. 3 is a structural diagram of a feature encoding model according to an example embodiment of the present disclosure;

FIG. 4 is a flowchart of a method for audio determination according to an example embodiment of the present disclosure;

FIG. 5 is a block diagram of a device for generating a feature encoding model according to an example embodiment of the present disclosure;

FIG. 6 is a block diagram of an apparatus for audio determination according to an example embodiment of the present disclosure; and

FIG. 7 is a schematic structural diagram of an electronic device according to an example embodiment of the present disclosure.

### DETAILED DESCRIPTION

Embodiments of the present disclosure will be described in more detail below with reference to the accompanying drawings. Although some embodiments of the present disclosure are shown in the drawings, it should be understood that the present disclosure can be embodied in various forms and should not be construed as limited to the embodiments set forth herein, but rather, these embodiments are provided for a more thorough and complete understanding of the present disclosure. It should be understood that the drawings and the embodiments of the present disclosure are only for illustrative purposes but not intended to limit the protection scope of the present disclosure.

It should be understood that the steps described in the method embodiments of the present disclosure can be executed in a different order and/or performed in parallel. In addition, the method embodiments may comprise additional steps and/or omit execution of the illustrated steps. The scope of the present disclosure is not limited in this regard.

As used herein, the term “comprising” and its variants are open-ended comprising, i.e., “comprising but not limited to”. The term “based on” is “at least partially based on”. The term “one embodiment” means “at least one embodiment”. The term “another embodiment” means “at least one other embodiment”. The term “some embodiments” means “at least some embodiments”. Related definitions of other terms will be given in the following descriptions.

It should be noted that the concepts of “first”, “second” and the like mentioned in the present disclosure are only intended to distinguish different devices, modules, or units, but are not intended to limit the order or interdependence of the functions performed by these devices, modules, or units.

It should be noted that the modifications of “a” and “plurality” mentioned in the present disclosure are schematic rather than limiting, and it should be understood by those skilled in the art that unless otherwise explicitly specified herein, these modifications should be understood as “one or more”.

According to the embodiments of the present disclosure, names of messages or information exchanged between a plurality of devices are used for illustrative purposes only and are not intended to limit the scopes of these messages or information.

The task of cover retrieval may be to retrieve, for a given audio, a target audio being the same audio as the given audio from a music library. In the related art, the task of cover retrieval is regarded as a task of classification, and a cover model is obtained by training according to a classification loss function, then a feature vector of the given audio is acquired according to the cover model, and the task of cover retrieval is completed based on the feature vector. The cover model is a simple model comprising a convolutional layer, a pooling layer, and a linear layer.

Since the cover model is only trained by the classification loss function, and the classification loss function emphasizes an inter-class distance, but does not pay attention to an intra-class distance, resulting in a large intra-class distance, the cover model cannot accurately classify audios of the same category, and the audios cannot be effectively distinguished using the feature vector output by the cover model, which reduces the identifiability of the feature vector, thus reducing the accuracy of a cover retrieval result. Besides, the cover model trained by this method is poor in robustness. In addition, the cover model is of a simple structure, so that the feature vector acquired by the cover model cannot effectively represent a cover feature of the corresponding audio, which further reduces the accuracy of the cover retrieval result.

Therefore, an embodiment of the present disclosure discloses a method for generating a feature encoding model, in which a target loss value of a target loss function can reduce the difference between encoding vectors of sample audios of the same category, increase the difference between encoding vectors of sample audios of different categories, and reduce the difference between category prediction values and category labels of the plurality of sample audios, so that the model pays attention to both the inter-class distance and the intra-class distance, which improves the identifiability of the feature vectors output by a trained feature encoding model to the audios, and in turn improves the accuracy of the cover retrieval result and the robustness of the trained feature encoding model. In addition, the structure of the feature encoding model is optimized, which further improves the identifiability of the feature vectors output by the feature encoding model to the audios and the accuracy of the cover retrieval result.

The technical solutions recited in the present disclosure will be described in detail with reference to the accompanying drawings by taking cover retrieval as an example. It should be understood that the method for audio determination and the feature encoding model disclosed by the present disclosure may be used in other scenarios of audio retrieval based on feature vectors, for example, audio deduplication based on the feature vectors, i.e., eliminating duplicated audios in a set of audios.

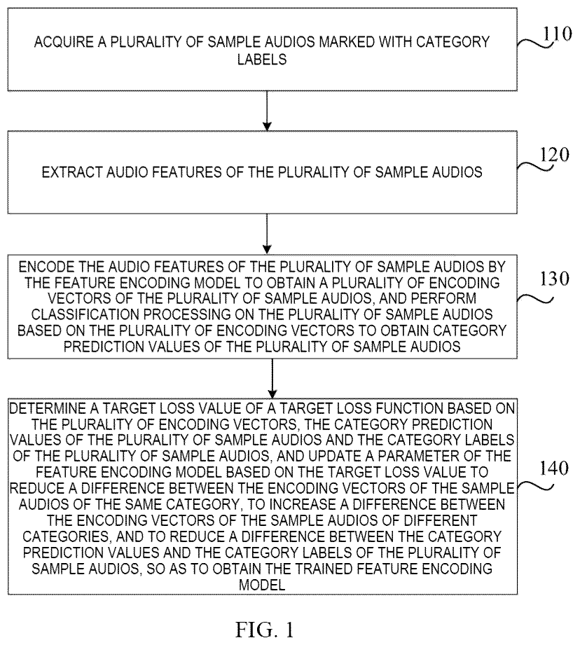

FIG. 1 is a flowchart of a method for generating a feature encoding model according to an example embodiment of the present disclosure. As shown in FIG. 1, the method comprises the following steps.

In step 110, a plurality of sample audios marked with category labels are acquired.

In some embodiments, the sample audio may be data input into a feature encoding model for training the feature coding model. The sample audio may comprise music data, for example, a song. In some embodiments, the label may be configured to characterize some real information of the sample audio, and the category label may be configured to characterize the category of the sample audio.

In some embodiments, the sample audios being the same audios among the plurality of sample audios may be marked with the same category label. For example, taking the sample audio as a song, the plurality of sample audios may comprise different versions of each of multiple songs, and songs corresponding to different versions of the same song may be marked with the same category label. It can be understood that the sample audios being the same audios and the sample audios not being the same audios among the plurality of sample audios may be distinguished by the category labels.

In some embodiments, the plurality of sample audios may be marked with the category labels through manual marking. In some embodiments, the plurality of sample audios may be acquired by a storage device or through calling a related interface.

In step 120, audio features of the plurality of sample audios are extracted.

In some embodiments, the audio feature may comprise at least one of a spectrum feature, a Mel-spectrum feature, a spectrogram feature, and a constant-Q transform (CQT) feature. In some embodiments, the spectrum features, the Mel-spectrum features, and the spectrogram features of the plurality of sample audios may be extracted according to Fourier transform, and the constant-Q transform features of the plurality of sample audios may be extracted by a constant-Q filter. In some embodiments, corresponding audio features may be extracted according to corresponding audio processing libraries. In some embodiments, the audio features of the plurality of sample audios may also be extracted by an audio feature extracting layer provided in the feature encoding model. It is worth noting that the audio feature may be acquired by the feature encoding model and may also be additionally acquired independently of the feature encoding model.

In some embodiments, the constant-Q transform feature may reflect the pitch of the sample audio at a corresponding pitch position at each time unit, the obtained constant-Q transform feature is a two-dimensional pitch-time matrix, and each element in the matrix represents the pitch at the corresponding time and at the corresponding pitch position. In some embodiments, the time unit may be specifically set according to actual situations, for example, 0.22 s. In some embodiments, the pitch position may be specifically set according to actual situations, for example, 12 pitch positions for each octave. It can be understood that the time unit and the pitch position may also be other numerical values. For example, the time unit is 0.1, and the pitch position is 6 pitches for each octave, which is not limited in the present disclosure.

The constant-Q transform feature containing time and pitch information may indirectly reflect melody information of the sample audio. Since the adaptation (or cover) of music usually keeps the melody of the music unchanged, the melody information can better reflect whether the audios are the same audio, which in turn makes an encoding vector output by the trained feature coding model to the audio can effectively characterize cover characteristics of the audio and improve the accuracy of the cover retrieval result. And in music data, sound is exponentially distributed, and features obtained by Fourier transform are linearly distributed, so that frequency points of sound and features obtained by Fourier transform are not in one-to-one correspondence, which may cause errors to estimated values of some scale frequencies. The constant-Q transform features have the law of exponential distribution consistent with sound distribution of the music data, and are more suitable for cover retrieval, which in turn improves the accuracy of the cover retrieval result.

In step 130, the audio features of the plurality of sample audios are encoded by the feature encoding model to obtain a plurality of encoding vectors of the plurality of sample audios, and classification processing on the plurality of sample audios is performed based on the plurality of encoding vectors to obtain category prediction values of the plurality of sample audios.

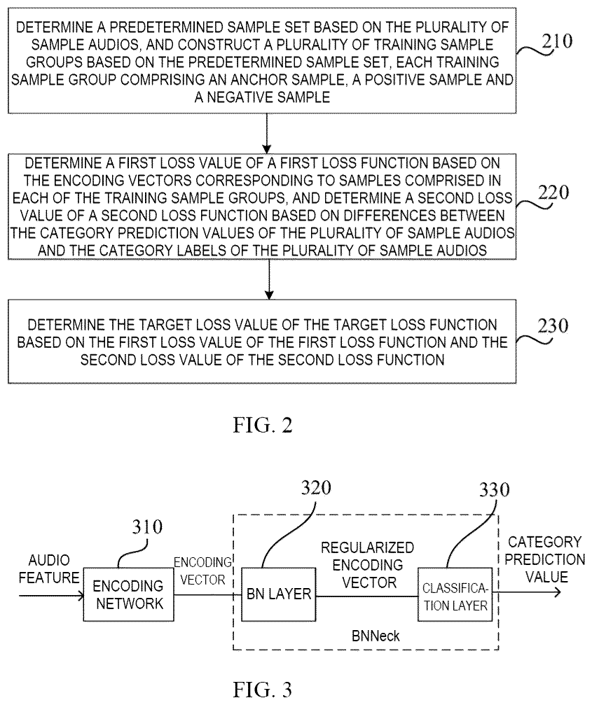

A reference may be made to FIG. 3 and its related descriptions for details about encoding and classification by the feature encoding model, which will not be repeated herein.

In step 140, a target loss value of a target loss function is determined based on the plurality of encoding vectors, the category prediction values of the plurality of sample audios and the category labels of the plurality of sample audios, and p a parameter of the feature encoding model is updated based on the target loss value to reduce a difference between the encoding vectors of the sample audios of the same category, to increase a difference between the encoding vectors of the sample audios of different categories, and to reduce a difference between the category prediction values and the category labels of the plurality of sample audios, so as to obtain the trained feature encoding model.

In some embodiments, the parameters of the feature encoding model may be updated based on the target loss value until the target loss value meets a predetermined condition. For example, the target loss value converges, or the target loss value is less than a predetermined value. When the target loss value meets the predetermined condition, training of the feature encoding model is completed, and the trained feature encoding model is obtained. A reference may be made to FIG. 2 and its related descriptions for specific details about determination of the target loss value of the target loss function, which will not be repeated herein.

In some embodiments, the difference between the encoding vectors of the sample audios of the same category and the difference between the encoding vectors of the sample audios of different categories may be characterized by the distances between the respective encoding vectors. Understandably, the smaller the distance is, the smaller the difference is. In some embodiments, the distance may comprise, but is not limited to, a cosine distance, a Euclidean distance, a Manhattan distance, a Mahalanobis distance or a Minkowski distance, etc.

In some embodiments, the difference between the encoding vectors of the sample audios of the same category may characterize the intra-class distance, and the difference between the encoding vectors of the sample audios of different categories and the difference between the category prediction values and the category labels of the plurality of sample audios may characterize the inter-class distance. It thus can be known that the loss value of the target loss function is related to both the inter-class distance and the intra-class distance, and both the inter-class distance and the intra-class distance are paid attention to in the process of training the feature encoding model, which improves the robustness of the trained feature encoding model and the identifiability of the feature vectors (i.e., encoding vectors) output by the feature encoding model.

In some embodiments, by reducing the difference between the encoding vectors of the sample audios of the same category and increasing the difference between the encoding vectors of the sample audios of different categories, the more similar the encoding vectors output by the feature encoding model to the sample audios of the same category are, the less similar the encoding vectors output by the feature encoding model to the sample audios of different categories are. It thus can be known that the encoding vectors output by the trained feature encoding model can effectively distinguish different audios to further improve the identifiability of the feature vectors output by the feature encoding model to the audios. The cover retrieval by the feature vectors output by the feature encoding model can improve the accuracy of the cover retrieval result.

By the above technical solutions, the target loss value of the target loss function for training the feature encoding model can reduce the difference between the encoding vectors of the sample audios of the same category, increase the difference between the encoding vectors of the sample audios of different categories, and reduce the difference between the category prediction values and the category labels of the plurality of sample audios, so that the feature encoding model pays attention to both the inter-class distance and the intra-class distance, which improves the robustness of the trained feature encoding model and the identifiability of the feature vectors output by the trained feature encoding model to the audios, and in turn improves the accuracy of a cover retrieval result.

FIG. 2 is a flowchart showing determining of a target loss value of a target loss function according to an example embodiment of the present disclosure. As shown in FIG. 2, the method comprises the following steps.

In step 210, a predetermined sample set is determined based on the plurality of sample audios, and a plurality of training sample groups are constructed based on the predetermined sample set, each training sample group comprising an anchor sample, a positive sample and a negative sample.

In some embodiments, the predetermined sample set may be a sample set composed of some or all sample audios of a plurality of sample audios. In some embodiments, the predetermined sample set may be composed of a predetermined number of randomly selected sample audios. Exemplarily, the predetermined sample set may be composed of P*K sample audios selected from a plurality of sample audios, where P denotes the number of categories, which may refer to the number of different category labels comprised in the sample audios in the predetermined sample set, K denotes the number of sample audios corresponding to each of the P categories, and both P and K are positive integers greater than 1.

In some embodiments, the anchor sample is any sample audio in the predetermined sample set, the positive sample is the sample audio in the predetermined sample set, which is of the same category as the anchor sample, and the negative sample is the sample audio in the predetermined sample set, which is not of the same category as the anchor sample. Exemplarily, still taking the above predetermined sample set comprising P*K sample audios as an example, P*K training sample groups may be constructed by the predetermined sample set.

In step 220, a first loss value of a first loss function is determined based on the encoding vectors corresponding to samples comprised in each of the training sample group, and a second loss value of a second loss function is determined based on differences between the category prediction values of the plurality of sample audios and the category labels of the plurality of sample audios.

In some embodiments, the encoding vectors corresponding to the samples comprised in each training sample group may refer to encoding vectors corresponding to the anchor sample, the positive sample, and the negative sample comprised in each training sample group. In some embodiments, the first loss function is used to reflect the difference between the encoding vector of the anchor sample and the encoding vector of the positive sample, and the difference between the encoding vector of the anchor sample and the encoding vector of the negative sample. As mentioned above, the difference between the encoding vectors may be characterized by distance. Therefore, in some embodiments, the first loss function may be constructed based on the distance between the encoding vector of the anchor sample and the encoding vector of the positive sample and the distance between the encoding vector of the anchor sample and the encoding vector of the negative sample.

In some embodiments, the first loss function may be a triple loss function, and a loss value of the triple loss function (i.e., the first loss value of the first loss function) may be obtained by the following formula (1):

$${loss}_{tri} = {[ d ( {x}_{i}^{a} , {x}_{i}^{p} ) - d ( {x}_{i}^{a} , {x}_{i}^{n} ) + ∝ ]}_{+} \qquad ( 1 )$$

in which lossₜᵣᵢ denotes the loss value of the triple loss function, xᵢ^{a} denotes the anchor sample, xᵢ^{p} denotes the positive sample, d(xᵢ^{a},xᵢ^{p}) denotes the distance between the anchor sample and the positive sample, xᵢⁿ denotes the negative sample, d(xᵢ^{a},xᵢⁿ) denotes the distance between the anchor sample and the negative sample, ∝ denotes a threshold, which may be set according to actual situations, and [ ]₊ indicates that when the value in “[ ]” is greater than 0, the value in “[ ]” is taken as the loss value, and when the value in “[ ]” is less than 0, the loss value is 0.

In some embodiments, the second loss function may be a classification loss function, for example, a cross entropy loss function, and correspondingly, the second loss value of the second loss function may be a loss value of the cross-entropy loss function. A reference may be made to the related knowledge in the art for the cross-entropy loss function, which will not be repeated herein.

In step 230, he target loss value of the target loss function is determined based on the first loss value of the first loss function and the second loss value of the second loss function.

In some embodiments, the target loss value may be determined according to the result of weighted summation of the first loss value and the second loss value. In the embodiments of the present disclosure, the target loss function used in training the feature encoding model is constructed by using the triple loss function and the classification loss function, i.e., a plurality of loss functions are used in training the feature encoding model, so that the intra-class distance is well controlled and the boundaries of different categories are more obvious, thereby improving the identifiability of the feature vectors output by the feature encoding model to the audios. In addition, the feature encoding model is obtained through end-to-end training, which improves the convenience of model training.

FIG. 3 is a structural diagram of a feature encoding model according to an example embodiment of the present disclosure. As shown in FIG. 3, the feature encoding model may comprise an encoding network 310. In some embodiments, encoding the audio features of the plurality of sample audios according to the encoding network to obtain the plurality of encoding vectors of the plurality of sample audios comprises: encoding audio features of a plurality of sample audios according to the encoding network 310 to obtain a plurality of encoding vectors of the plurality of sample audios.

In some embodiments, the encoding network 310 may comprise a residual network or a convolutional network. The residual network or convolutional network may be specifically determined according to actual situations. For example, the residual network may comprise ResNet50 or ResNet50-IBN, and the convolutional network may comprise VGG16 or the like.

In some embodiments, the residual network may comprise at least one of an instance normalization (IN) layer and a batch normalization (BN) layer. In some embodiments, ResNet50-IBN may comprise an IN layer and a BN layer. The IN layer enables the feature encoding network to learn stylistically invariant features of music to make better use of the stylistically diverse music corresponding to the plurality of sample audios, and the BN layer makes it easier to extract the information about the content of the sample audios, such as tune, rhythm, timbre, volume, and genre. It is easier to extract the information in audio features by the IN layer and the BN layer in the ResNet50-IBN network, so that the encoding vector output by the encoding network 310 can effectively represent cover features of the corresponding sample audios.

In some embodiments, the encoding network 310 may further comprise a Generalized mean (GeM) pooling layer. Encoding the audio features of the plurality of sample audios according to the encoding network 310 to obtain the plurality of encoding vectors of the plurality of sample audios comprises: encoding the audio features of the plurality of sample audios according to the residual network or the convolutional network to obtain a plurality of initial encoding vectors of the plurality of sample audios; and processing the plurality of initial encoding vectors according to the GeM pooling layer to obtain the plurality of encoding vectors of the plurality of sample audios. The GeM pooling layer allows reduction of the loss of features obtained after the audio features are encoded by the residual network or the convolutional network. For example, the GeM pooling layer can reduce the loss of features obtained after encoding by the ResNet50-IBN network, which in turn improves the effectiveness of cover features characterized by the encoding vectors of the sample features.

In some embodiments, the encoding vector output by the encoding network 310 of the trained feature encoding model may be used as the feature vector of the audio output by the feature encoding model. In some embodiments, the encoding vector output by the residual network or the convolutional network in the encoding network 310 may be used as the feature vector of the audio output by the trained feature encoding model, or the encoding vector output by the GeM pooling layer in the encoding network 310 may be used as the feature vector of the audio output by the trained feature encoding model.

In some embodiments, the feature encoding model comprises a BN layer 320 and a classification layer 330, and the method for generating a feature encoding model further comprises: processing the plurality of encoding vectors according to the BN layer 320 to obtain a plurality of regularized encoding vectors; and performing classification processing on the plurality of sample audios based on the plurality of encoding vectors to obtain the category prediction values of the plurality of sample audios comprising: performing classification processing on the plurality of regularized encoding vectors according to the classification layer 330 to obtain the category prediction values of the plurality of sample audios. The encoding vector output from the BN layer 320 of the trained feature encoding model may be used as the feature vector of the audio output by the feature encoding model.

In some embodiments, the BN layer 320 may be arranged between the encoding network 310 or the GeM pooling layer and the classification layer 330, and the BN layer 320 and the classification layer 330 constitute BNNeck. The encoding vectors output by the encoding network 310 or the GeM pooling layer may be used for calculating the first loss value, and the plurality of encoding vectors are processed by the BN layer 320 to obtain the plurality of regularized encoding vector. The regularization balances the features of individual dimensions in the encoding vectors, so that the second loss value calculated from the category prediction values obtained by classification based on the plurality of regularized encoding vectors is more likely to converge. BNNeck reduces the constraints of the encoding vectors of the second loss value before the BN layer (i.e., the encoding vector output by the encoding network or the GeM pooling layer), the less constraints of the second loss value make the first loss value easier to converge at the same time, and in turn, the training efficiency of the feature encoding model can be improved by BNNeck. In addition, BNNeck can better maintain the inter-class boundary, so that the feature encoding model and the feature vectors output by the feature encoding model to the audios significantly enable enhancement in identifiability and robustness.

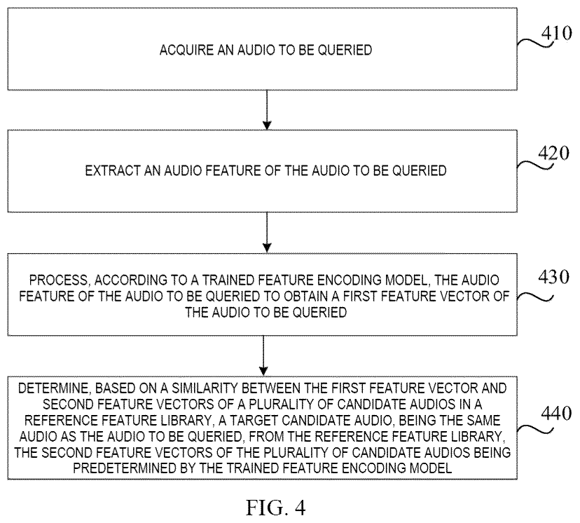

FIG. 4 is a flowchart of a method for audio determination according to an example embodiment of the present disclosure. As shown in FIG. 4, the method comprises the following steps.

In step 410, an audio to be queried is acquired.

In step 420, an audio feature of the audio to be queried is extracted.

In some embodiments, the audio to be queried may be an audio whose cover version needs to be queried, for example, a song whose cover song needs to be queried. A reference may be made to steps 110 and 120 for specific details of steps 410 and 420, which are similar to those of steps 110 and 120 above and thus will not be repeated herein.

In step 430, the audio feature of the audio to be queried is processed according to a trained feature encoding model to obtain a first feature vector of the audio to be queried.

In some embodiments, the first feature vector of the audio to be queried may be an encoding vector output by an encoding network (for example, a residual network, a convolutional network, or a GeM pooling layer) or a BN layer after the trained feature encoding model processes the audio to be queried. A reference may be made to relevant descriptions in FIG. 3 for the specific details of step 430, which will not be repeated herein.

In step 440, a target candidate audio, being the same audio as the audio to be queried, is determined from the reference feature library based on a similarity between the first feature vector and second feature vectors of a plurality of candidate audios in a reference feature library, and the second feature vectors of the plurality of candidate audios being predetermined by the trained feature encoding model.

In some embodiments, the feature encoding model is obtained by the method for generating a feature encoding model described in steps 110-140 above. In some embodiments, being the same audio may mean that the audio to be queried and the target candidate audio are different renditions of the same audio, and for example, the audio to be queried and the target candidate audio are different cover versions of the same song.

In some embodiments, a candidate audio with a similarity greater than a predetermined threshold may be determined as the target candidate audio. The predetermined threshold may be set according to actual situations, for example, 0.95 or 0.98, etc. In the embodiments of the present disclosure, owing to high identifiability of the feature vectors output by the feature encoding model, the target candidate audio being the same audio as the audio to be queried may be accurately retrieved by the feature vectors output by the feature encoding model, which improves the accuracy of the retrieval result, i.e., improves the accuracy of the cover retrieval result.

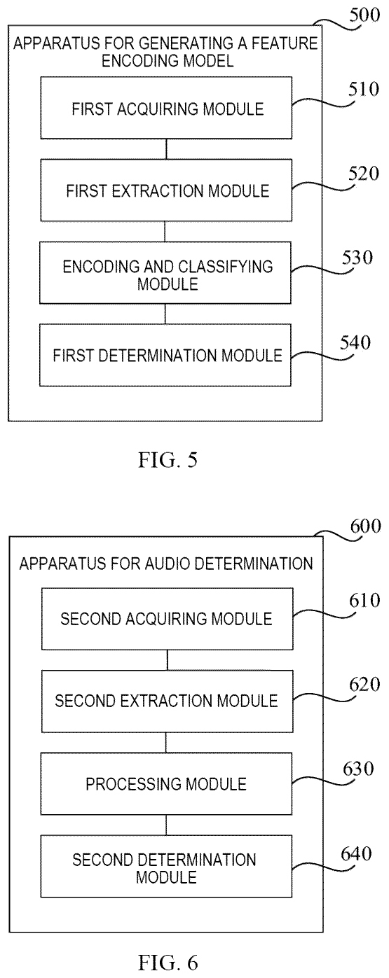

FIG. 5 is a block diagram of an apparatus for generating a feature encoding model according to an example embodiment of the present disclosure. As shown in FIG. 5, the apparatus 500 comprises:
a first acquiring module 510 configured to acquire a plurality of sample audios marked with category labels;
a first extraction module 520 configured to extract audio features of the plurality of sample audios;
an encoding and classifying module 530 configured to encode the audio features of the plurality of sample audios by the feature encoding model to obtain a plurality of encoding vectors of the plurality of sample audios, and performing classification processing on the plurality of sample audios based on the plurality of encoding vectors to obtain category prediction values of the plurality of sample audios; and
a first determination module 540 configured to determine a target loss value of a target loss function based on the plurality of encoding vectors, the category prediction values of the plurality of sample audios and the category labels of the plurality of sample audios, and updating a parameter of the feature encoding model based on the target loss value to reduce a difference between the encoding vectors of the sample audios of the same category, to increase a difference between the encoding vectors of the sample audios of different categories, and to reduce a difference between the category prediction values and the category labels of the plurality of sample audios, so as to obtain the trained feature encoding model.

In some embodiments, the first determination module 540 is further configured for:
determining a predetermined sample set based on the plurality of sample audios, and constructing a plurality of training sample groups based on the predetermined sample set, each training sample group comprising an anchor sample, a positive sample and a negative sample, wherein the anchor sample is any sample audio in the predetermined sample set, the positive sample is the sample audio in the predetermined sample set, which is of the same category as the anchor sample, the negative sample is the sample audio in the predetermined sample set, which is not of the same category as the anchor sample;
determining a first loss value of a first loss function based on the encoding vectors corresponding to samples comprised in each of the training sample groups, the first loss function being used to reflect a difference between the encoding vector of the anchor sample and the encoding vector of the positive sample, and a difference between the encoding vector of the anchor sample and the encoding vector of the negative sample, and determining a second loss value of a second loss function based on differences between the category prediction values of the plurality of sample audios and the category labels of the plurality of sample audios; and
determining the target loss value of the target loss function based on the first loss value of the first loss function and the second loss value of the second loss function.

In some embodiments, the feature encoding model comprises an encoding network, and the encoding and classifying module 530 is further configured for:
encoding the audio features of the plurality of sample audios according to the encoding network to obtain the plurality of encoding vectors of the plurality of sample audios, the encoding network comprising a residual network or a convolutional network, wherein an encoding vector output by the encoding network of the trained feature encoding model is usable as a feature vector of an audio output by the feature encoding model.

In some embodiments, the residual network comprises at least one of an instance normalization (IN) layer and a batch normalization (BN) layer.

In some embodiments, the encoding network further comprises a GeM pooling layer, and the encoding and classifying module 530 is further configured for:
encoding the audio features of the plurality of sample audios according to the residual network or the convolutional network to obtain a plurality of initial encoding vectors of the plurality of sample audios; and
processing the plurality of initial encoding vectors according to the GeM pooling layer to obtain the plurality of encoding vectors of the plurality of sample audios.

In some embodiments, the feature encoding model comprises a BN layer and a classification layer, and the apparatus 500 further comprises a regularization processing module configured for processing the plurality of encoding vectors according to the BN layer to obtain a plurality of regularized encoding vectors; and
the encoding and classifying module 530 is further configured for:
performing classification processing on the plurality of regularized encoding vectors according to the classification layer to obtain the category prediction values of the plurality of sample audios, wherein an encoding vector output from the BN layer of the trained feature encoding model is usable as a feature vector of an audio output by the feature encoding model.

FIG. 6 is a block diagram of an apparatus for audio determination according to an example embodiment of the present disclosure. As shown in FIG. 6, the apparatus 600 comprises:
a second acquiring module 610 configured to acquire an audio to be queried;
a second extraction module 620 configured to extract an audio feature of the audio to be queried;
a processing module 630 configured to process, according to a trained feature encoding model, the audio to be queried to obtain a first feature vector of the audio to be queried; and
a second determination module 640 configured to determine, based on a similarity between the first feature vector and second feature vectors of a plurality of candidate audios in a reference feature library, a target candidate audio, being the same audio as the audio to be queried, from the reference feature library, the second feature vectors of the plurality of candidate audios being predetermined by the trained feature encoding model; wherein the feature encoding model is obtained by the method for generating a feature coding model according to the embodiments of the present disclosure.

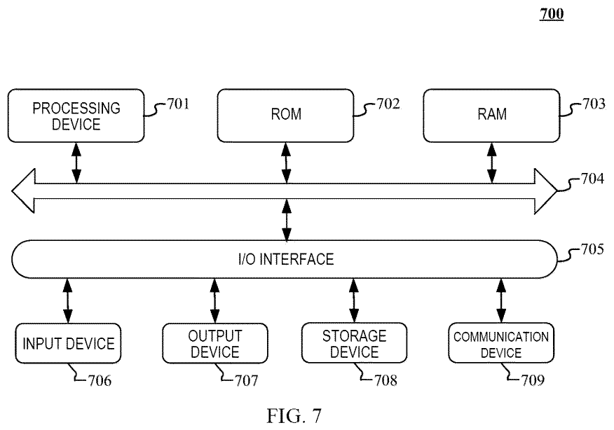

Reference is made below to FIG. 7, which is a schematic structural diagram of an electronic device 700 suitable for implementing the embodiments of the present disclosure. According to an embodiment of the present disclosure, a terminal device may comprise, but is not limited to, mobile terminals such as a mobile phone, a notebook computer, a digital broadcast receiver, a personal digital assistant (PDA), a tablet PC (PAD), a portable multimedia player (PMP) and a vehicle-mounted terminal (for example, a vehicle-mounted navigation terminal), and fixed terminals such as a digital TV and a desktop computer. The electronic device shown in FIG. 7 is merely an example and should not impose any limitation on the function or the scope of application of the embodiments of the present disclosure.

As shown in FIG. 7, the electronic device 700 may comprise a processing device (such as a central processing unit and a graphics processing unit) 701 which may execute various appropriate actions and processing according to a program stored in a read-only memory (ROM) 702 or a program loaded from a storage device 708 to a random-access memory (RAM) 703. Various programs and data required during operation of the electronic device 700 are also stored in the RAM 703. The processing device 701, the ROM 702 and the RAM 703 are connected with one another via a bus 704. An input/output (I/O) interface 705 is also connected to the bus 704.

Generally, the following devices may be connected to the I/O interface 705: an input device 706 comprising a touch screen, a touch pad, a keyboard, a mouse, a camera, a microphone, an accelerometer, a gyroscope and the like, for example; an output device 707 comprising a liquid crystal display (LCD), a speaker, a vibrator and the like, for example; the storage device 708 comprising a magnetic tape, a hard disk and the like, for example; and a communication device 709. The communication device 709 may allow the electronic device 700 to be in wireless or wired communication with other devices for data exchange. Although FIG. 7 shows the electronic device 700 having various means, it should be understood that it is not required to implement or provide all the means shown. More or fewer devices may alternatively be implemented or provided.

In particular, according to the embodiments of the present disclosure, the process described above with reference to the flowcharts may be implemented as a computer software program. For example, according to an embodiment of the present disclosure, a computer program product is provided and comprises a computer program carried on a non-transitory computer-readable medium, and the computer program includes a program code for executing the methods shown in the flowcharts. In such an embodiment, the computer program may be downloaded and installed from a network via the communication device 709, or installed from the storage device 708, or installed from the ROM 702. The computer program, when executed by the processing device 701, serves the above functions defined in the methods of the embodiments of the present disclosure.

It should be noted that the computer-readable medium as described in the present disclosure may be a computer-readable signal medium or a computer-readable storage medium or any combination thereof. The computer-readable storage medium may be, for example, but is not limited to, an electrical, magnetic, optical, electromagnetic, infrared, or semiconductor-based system, apparatus, or device, or any combination thereof. More specific examples of the computer-readable storage medium may comprise, but are not limited to, an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program, and the program may be used by or in combination with an instruction execution system, apparatus, or device. Further, in the present disclosure, the computer-readable signal medium may comprise a data signal propagated in baseband or as a part of a carrier wave, in which the computer-readable program code is carried. This propagated data signal may be in various forms, comprising but not limited to electromagnetic signals, optical signals, or any suitable combination thereof. The computer-readable signal medium may also be any computer-readable medium other than the computer-readable storage medium, and the computer-readable signal medium may send, propagate, or transmit the program for use by or in connection with the instruction execution system, apparatus, or device. The program code included in the computer-readable medium may be transmitted by any suitable medium, comprising but not limited to an electric wire, an optical cable, radio frequency (RF) and the like, or any suitable combination thereof.

In some embodiments, any currently known or future-developed network protocol such as Hyper Text Transfer Protocol (HTTP), for example, may be used for communication and may be interconnected with digital data communications (e.g., communication networks) in any form or medium. Examples of the communication networks comprise local area network (LAN), wide area network (WAN), inter-network (e.g., the Internet), and end-to-end network (e.g., ad hoc end-to-end network), as well as any currently known or future developed networks.

The computer-readable medium may be included in the electronic device or may stand alone and not be assembled in the electronic device.

The computer-readable medium carries at least one computer program, and the at least one computer program, when executed by the electronic device, causes the electronic device to: acquire a plurality of sample audios marked with category labels; extract audio features of the plurality of sample audios; encode the audio features of the plurality of sample audios by the feature encoding model to obtain a plurality of encoding vectors of the plurality of sample audios, and perform classification processing on the plurality of sample audios based on the plurality of encoding vectors to obtain category prediction values of the plurality of sample audios; and determine a target loss value of a target loss function based on the plurality of encoding vectors, the category prediction values of the plurality of sample audios and the category labels of the plurality of sample audios, and update parameters of the feature encoding model based on the target loss value to reduce the difference between the encoding vectors of the sample audios of the same category, to increase the difference between the encoding vectors of the sample audios of different categories, and to reduce the difference between the category prediction values and the category labels of the plurality of sample audios, thereby obtaining a trained feature encoding model.

Alternatively, the computer-readable medium carries at least one computer program, and the at least one computer program, when executed by the electronic device, causes the electronic device to: acquire an audio to be queried; extract an audio feature of the audio to be queried; process, according to a trained feature encoding model, the audio feature of the audio to be queried to obtain a first feature vector of the audio to be queried; and determine, based on a similarity between the first feature vector and second feature vectors of a plurality of candidate audios in a reference feature library, a target candidate audio, being the same audio as the audio to be queried, from the reference feature library, the second feature vectors of the plurality of candidate audios being predetermined by the trained feature encoding model; wherein the feature encoding model is obtained by the method for generating a feature encoding model according to the embodiments of the present disclosure.

The computer program code used to perform the operations of the present disclosure may be written in one or more programming languages or a combination thereof. The programming languages comprise, but not limited to, object-oriented programming languages such as Java, Smalltalk, and C++, and also comprise conventional procedural programming languages such as “C” language or similar programming languages. The program code may be executed entirely on a user's computer, partly on the user's computer, as an independent software package, partly on the user's computer and partly on a remote computer, or entirely on the remote computer or server. In the case of a remote computer, the remote computer may be connected to the user's computer over any kind of network comprising a local area network (LAN) or a wide area network (WAN), or it may be connected to an external computer (for example, using an Internet service provider to connect over the Internet).

The flowcharts and the block diagrams in the accompanying drawings show the architectures, functions and operations that may be implemented by the system, method, and computer program product according to the embodiments of the present disclosure. In this regard, each block in the flowcharts or the block diagrams may represent a part of a module, a program segment or a code, and the part of the module, the program segment or the code contains one or more executable instructions for implementing the specified logical functions. It should also be noted that in some implementations as alternatives, the functions labeled in the blocks may occur in an order different from the order labeled in the accompanying drawings. For example, two sequentially shown blocks may be substantially executed in parallel in fact, and they sometimes may also be executed in a reverse order, depending on the involved functions. It should also be noted that each block in the block diagrams and/or the flowcharts and the combination of the blocks in the block diagrams and/or the flowcharts may be implemented by a dedicated hardware-based system for executing the specified functions or operations or may be implemented by a combination of the dedicated hardware and computer instructions.

The involved modules described in the embodiments of the present disclosure may be implemented by software or hardware. The names of the modules do not define the modules themselves in some cases.

The functions described above herein may be performed, at least in part, by one or more hardware logic components. For example, without limitation, example types of the hardware logic components that may be used include: field programmable gate arrays (FPGAs), application-specific integrated circuits (ASICs), application-specific standard products (ASSPs), systems-on-chip (SOCs), complex programmable logic devices (CPLDs), and the like.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may comprise, but is not limited to, an electronic, magnetic, optical, electromagnetic, infrared, or semiconductor-based system, apparatus or device, or any suitable combination thereof. More specific examples of the machine-readable storage medium may comprise: an electrical connection based on one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

According to one or more embodiments of the present disclosure, Example 1 provides a method for generating a feature encoding model, comprising:
acquiring a plurality of sample audios marked with category labels;
extracting audio features of the plurality of sample audios;
encoding the audio features of the plurality of sample audios by the feature encoding model to obtain a plurality of encoding vectors of the plurality of sample audios, and performing classification processing on the plurality of sample audios based on the plurality of encoding vectors to obtain category prediction values of the plurality of sample audios; and
determining a target loss value of a target loss function based on the plurality of encoding vectors, the category prediction values of the plurality of sample audios and the category labels of the plurality of sample audios, and updating a parameter of the feature encoding model based on the target loss value to reduce a difference between the encoding vectors of the sample audios of the same category, to increase a difference between the encoding vectors of the sample audios of different categories, and to reduce a difference between the category prediction values and the category labels of the plurality of sample audios, so as to obtain the trained feature encoding model.

According to one or more embodiments of the present disclosure, Example 2 provides the method of Example 1, wherein determining a target loss value of a target loss function based on the plurality of encoding vectors, the category prediction values of the plurality of sample audios and the category labels of the plurality of sample audios comprises:
determining a predetermined sample set based on the plurality of sample audios, and constructing a plurality of training sample groups based on the predetermined sample set, each training sample group comprising an anchor sample, a positive sample and a negative sample, wherein the anchor sample is any sample audio in the predetermined sample set, the positive sample is the sample audio in the predetermined sample set, which is of the same category as the anchor sample, the negative sample is the sample audio in the predetermined sample set, which is not of the same category as the anchor sample;
determining a first loss value of a first loss function based on the encoding vectors corresponding to samples comprised in each of the training sample groups, the first loss function being used to reflect a difference between the encoding vector of the anchor sample and the encoding vector of the positive sample, and a difference between the encoding vector of the anchor sample and the encoding vector of the negative sample, and determining a second loss value of a second loss function based on differences between the category prediction values of the plurality of sample audios and the category labels of the plurality of sample audios; and
determining the target loss value of the target loss function based on the first loss value of the first loss function and the second loss value of the second loss function.

According to one or more embodiments of the present disclosure, Example 3 provides the method of Example 1, wherein the feature encoding model comprises an encoding network, and encoding the audio features of the plurality of sample audios by the feature encoding model to obtain a plurality of encoding vectors of the plurality of sample audios comprises:
encoding the audio features of the plurality of sample audios according to the encoding network to obtain the plurality of encoding vectors of the plurality of sample audios, the encoding network comprising a residual network or a convolutional network, wherein an encoding vector output by the encoding network of the trained feature encoding model is usable as a feature vector of an audio output by the feature encoding model.

According to one or more embodiments of the present disclosure, Example 4 provides the method of Example 3, wherein the residual network comprises at least one of an instance normalization (IN) layer and a batch normalization (BN) layer.

According to one or more embodiments of the present disclosure, Example 5 provides the method of Example 3, wherein the encoding network further comprises a GeM pooling layer, and encoding the audio features of the plurality of sample audios according to the encoding network to obtain the plurality of encoding vectors of the plurality of sample audios comprises:
encoding the audio features of the plurality of sample audios according to the residual network or the convolutional network to obtain a plurality of initial encoding vectors of the plurality of sample audios; and
processing the plurality of initial encoding vectors according to the GeM pooling layer to obtain the plurality of encoding vectors of the plurality of sample audios.

According to one or more embodiments of the present disclosure, Example 6 provides the method of any of Examples 1-5, wherein the feature encoding model comprises a BN layer and a classification layer, and the method further comprises:
processing the plurality of encoding vectors according to the BN layer to obtain a plurality of regularized encoding vectors; and
performing classification processing on the plurality of sample audios based on the plurality of encoding vectors to obtain the category prediction values of the plurality of sample audios comprises:
performing classification processing on the plurality of regularized encoding vectors according to the classification layer to obtain the category prediction values of the plurality of sample audios, wherein an encoding vector output from the BN layer of the trained feature encoding model is usable as a feature vector of an audio output by the feature encoding model.

According to one or more embodiments of the present disclosure, Example 7 provides a method for audio determination, comprising:
acquiring an audio to be queried;
extracting an audio feature of the audio to be queried;
processing, according to a trained feature encoding model, the audio feature of the audio to be queried to obtain a first feature vector of the audio to be queried; and
determining, based on a similarity between the first feature vector and second feature vectors of a plurality of candidate audios in a reference feature library, a target candidate audio, being the same audio as the audio to be queried, from the reference feature library, the second feature vectors of the plurality of candidate audios being predetermined by the trained feature encoding model;
wherein the feature encoding model is obtained by the method for generating a feature coding model according to any of Examples 1-6.

According to one or more embodiments of the present disclosure, Example 8 provides an apparatus for training a feature encoding model, comprising:
a first acquiring module configured to acquire a plurality of sample audios marked with category labels;
a first extraction module configured to extract audio features of the plurality of sample audios;
an encoding and classifying module configured to encode the audio features of the plurality of sample audios by the feature encoding model to obtain a plurality of encoding vectors of the plurality of sample audios, and performing classification processing on the plurality of sample audios based on the plurality of encoding vectors to obtain category prediction values of the plurality of sample audios; and
a first determination module configured to determine a target loss value of a target loss function based on the plurality of encoding vectors, the category prediction values of the plurality of sample audios and the category labels of the plurality of sample audios, and updating a parameter of the feature encoding model based on the target loss value to reduce a difference between the encoding vectors of the sample audios of the same category, to increase a difference between the encoding vectors of the sample audios of different categories, and to reduce a difference between the category prediction values and the category labels of the plurality of sample audios, so as to obtain the trained feature encoding model.

According to one or more embodiments of the present disclosure, Example 9 provides the device of Example 8, in which the first determination module is further configured for:
determining a predetermined sample set based on the plurality of sample audios, and constructing a plurality of training sample groups based on the predetermined sample set, each training sample group comprising an anchor sample, a positive sample and a negative sample, wherein the anchor sample is any sample audio in the predetermined sample set, the positive sample is the sample audio in the predetermined sample set, which is of the same category as the anchor sample, the negative sample is the sample audio in the predetermined sample set, which is not of the same category as the anchor sample;
determining a first loss value of a first loss function based on the encoding vectors corresponding to samples comprised in each of the training sample groups, the first loss function being used to reflect a difference between the encoding vector of the anchor sample and the encoding vector of the positive sample, and a difference between the encoding vector of the anchor sample and the encoding vector of the negative sample, and determining a second loss value of a second loss function based on differences between the category prediction values of the plurality of sample audios and the category labels of the plurality of sample audios; and
determining the target loss value of the target loss function based on the first loss value of the first loss function and the second loss value of the second loss function.

According to one or more embodiments of the present disclosure, Example 10 provides the device of Example 8, wherein the feature encoding model comprises an encoding network, and the encoding and classifying module is further configured for:
encoding the audio features of the plurality of sample audios according to the encoding network to obtain the plurality of encoding vectors of the plurality of sample audios, the encoding network comprising a residual network or a convolutional network, wherein an encoding vector output by the encoding network of the trained feature encoding model is usable as a feature vector of an audio output by the feature encoding model.

According to one or more embodiments of the present disclosure, Example 11 provides the device of Example 10, wherein the residual network comprises at least one of an instance normalization (IN) layer and a batch normalization (BN) layer.

According to one or more embodiments of the present disclosure, Example 12 provides the device of Example 10, wherein the encoding network further comprises a GeM pooling layer, and the encoding and classifying module is further configured for:
encoding the audio features of the plurality of sample audios according to the residual network or the convolutional network to obtain a plurality of initial encoding vectors of the plurality of sample audios; and
processing the plurality of initial encoding vectors according to the GeM pooling layer to obtain the plurality of encoding vectors of the plurality of sample audios.

According to one or more embodiments of the present disclosure, Example 13 provides the apparatus of any of Examples 8-12, wherein the feature encoding model comprises a BN layer and a classification layer, and the apparatus further comprises a regularization processing module configured for processing the plurality of encoding vectors according to the BN layer to obtain a plurality of regularized encoding vectors; and
the encoding and classifying module is further configured for:
performing classification processing on the plurality of regularized encoding vectors according to the classification layer to obtain the category prediction values of the plurality of sample audios, wherein an encoding vector output from the BN layer of the trained feature encoding model is usable as a feature vector of an audio output by the feature encoding model.

According to one or more embodiments of the present disclosure, Example 14 provides an apparatus for audio determination, comprising:
a second acquiring module configured to acquire an audio to be queried;
a second extraction module configured to extract an audio feature of the audio to be queried;
a processing module configured to process, according to a trained feature encoding model, the audio to be queried to obtain a first feature vector of the audio to be queried; and
a second determination module configured to determine, based on a similarity between the first feature vector and second feature vectors of a plurality of candidate audios in a reference feature library, a target candidate audio, being the same audio as the audio to be queried, from the reference feature library, the second feature vectors of the plurality of candidate audios being predetermined by the trained feature encoding model;
wherein the feature encoding model is obtained by the method for generating a feature coding model according to any of Examples 1-6.

According to one or more embodiments of the present disclosure, Example 15 provides a computer-readable medium storing a computer program thereon, wherein the program, when executed by a processing device, implements the steps of the method of any of Examples 1-7.

According to one or more embodiments of the present disclosure, Example 16 provides an electronic device, comprising:
a storage device storing at least one computer program thereon; and
at least one processing device being used to execute the at least one computer program in the storage device to implement the steps of the method of any of Examples 1-7.

The above description is only a preferred embodiment of the present disclosure and an illustration of the technical principles utilized. It should be understood by those skilled in the art that the scope of disclosure involved in the present disclosure is not limited to technical solutions formed by a particular combination of the above technical features, but also covers other technical solutions formed by any combination of the above technical features or their equivalent features without departing from the above disclosed concept, for example, a technical solution formed by interchanging the above features with (but not limited to) technical features with similar functions as disclosed in the present disclosure.

Furthermore, while the operations are depicted using a particular order, this should not be construed as requiring that the operations are performed in the particular order shown or in sequential order of execution. Multitasking and parallel processing may be advantageous in certain environments. Similarly, while several specific implementation details are comprised in the above discussion, these should not be construed as limiting the scope of the present disclosure. Certain features described in the context of separate embodiments may also be implemented in combination in a single embodiment. Conversely, various features described in the context of a single embodiment may also be implemented in multiple embodiments, either individually or in any suitable sub-combination.

Although the present subject matter has been described using language specific to structural features and/or method logical actions, it should be understood that the subject matter limited in the appended claims is not necessarily limited to the particular features or actions described above. Rather, the particular features and actions described above are merely example forms of implementing the claims. With respect to the apparatus in the above embodiments, the specific manner in which the individual modules perform the operations has been described in detail in the embodiments relating to the method and will not be described in detail herein.

1-11. (canceled)

12. A method for generating a feature encoding model, comprising:
acquiring a plurality of sample audios marked with category labels;
extracting audio features of the plurality of sample audios;
encoding the audio features of the plurality of sample audios by the feature encoding model to obtain a plurality of encoding vectors of the plurality of sample audios, and performing classification processing on the plurality of sample audios based on the plurality of encoding vectors to obtain category prediction values of the plurality of sample audios; and
determining a target loss value of a target loss function based on the plurality of encoding vectors, the category prediction values of the plurality of sample audios and the category labels of the plurality of sample audios, and updating a parameter of the feature encoding model based on the target loss value to reduce a difference between the encoding vectors of the sample audios of a same category, to increase a difference between the encoding vectors of the sample audios of different categories, and to reduce a difference between the category prediction values and the category labels of the plurality of sample audios, so as to obtain the trained feature encoding model.

13. The method according to claim 12, wherein determining the target loss value of the target loss function based on the plurality of encoding vectors, the category prediction values of the plurality of sample audios and the category labels of the plurality of sample audios comprises:
determining a predetermined sample set based on the plurality of sample audios, and constructing a plurality of training sample groups based on the predetermined sample set, each training sample group comprising an anchor sample, a positive sample and a negative sample, wherein the anchor sample is any sample audio in the predetermined sample set, the positive sample is the sample audio in the predetermined sample set, which is of the same category as the anchor sample, the negative sample is the sample audio in the predetermined sample set, which is not of the same category as the anchor sample;
determining a first loss value of a first loss function based on the encoding vectors corresponding to samples comprised in each of the training sample groups, the first loss function being used to reflect a difference between the encoding vector of the anchor sample and the encoding vector of the positive sample, and a difference between the encoding vector of the anchor sample and the encoding vector of the negative sample, and determining a second loss value of a second loss function based on differences between the category prediction values of the plurality of sample audios and the category labels of the plurality of sample audios; and
determining the target loss value of the target loss function based on the first loss value of the first loss function and the second loss value of the second loss function.

14. The method according to claim 12, wherein the feature encoding model comprises an encoding network, and encoding the audio features of the plurality of sample audios by the feature encoding model to obtain the plurality of encoding vectors of the plurality of sample audios comprises:
encoding the audio features of the plurality of sample audios according to the encoding network to obtain the plurality of encoding vectors of the plurality of sample audios, the encoding network comprising a residual network or a convolutional network, wherein an encoding vector output by the encoding network of the trained feature encoding model is usable as a feature vector of an audio output by the feature encoding model.

15. The method according to claim 14, wherein the residual network comprises at least one of an instance normalization (IN) layer and a batch normalization (BN) layer.

16. The method according to claim 14, wherein the encoding network further comprises a GeM pooling layer, and encoding the audio features of the plurality of sample audios according to the encoding network to obtain the plurality of encoding vectors of the plurality of sample audios comprises:
encoding the audio features of the plurality of sample audios according to the residual network or the convolutional network to obtain a plurality of initial encoding vectors of the plurality of sample audios; and
processing the plurality of initial encoding vectors according to the GeM pooling layer to obtain the plurality of encoding vectors of the plurality of sample audios.

17. The method according to claim 12, wherein the feature encoding model comprises a BN layer and a classification layer, and the method further comprises:
processing the plurality of encoding vectors according to the BN layer to obtain a plurality of regularized encoding vectors; and
performing classification processing on the plurality of sample audios based on the plurality of encoding vectors to obtain the category prediction values of the plurality of sample audios comprises:
performing classification processing on the plurality of regularized encoding vectors according to the classification layer to obtain the category prediction values of the plurality of sample audios, wherein an encoding vector output from the BN layer of the trained feature encoding model is usable as a feature vector of an audio output by the feature encoding model.

18. The method according to claim 12, wherein the audio features of the plurality of sample audios comprises at least of:
a spectrum feature,
a Mel-spectrum feature,
a spectrogram feature, and
a constant-Q transform (CQT) feature.

19. A method for audio determination, comprising:
acquiring an audio to be queried;
extracting an audio feature of the audio to be queried;
processing, according to a trained feature encoding model, the audio feature of the audio to be queried to obtain a first feature vector of the audio to be queried; and
determining, based on a similarity between the first feature vector and second feature vectors of a plurality of candidate audios in a reference feature library, a target candidate audio, being a same audio as the audio to be queried, from the reference feature library, the second feature vectors of the plurality of candidate audios being predetermined by the trained feature encoding model;
wherein the feature encoding model is obtained by acts comprising:
acquiring a plurality of sample audios marked with category labels;
extracting audio features of the plurality of sample audios;
encoding the audio features of the plurality of sample audios by the feature encoding model to obtain a plurality of encoding vectors of the plurality of sample audios, and performing classification processing on the plurality of sample audios based on the plurality of encoding vectors to obtain category prediction values of the plurality of sample audios; and
determining a target loss value of a target loss function based on the plurality of encoding vectors, the category prediction values of the plurality of sample audios and the category labels of the plurality of sample audios, and updating a parameter of the feature encoding model based on the target loss value to reduce a difference between the encoding vectors of the sample audios of a same category, to increase a difference between the encoding vectors of the sample audios of different categories, and to reduce a difference between the category prediction values and the category labels of the plurality of sample audios, so as to obtain the trained feature encoding model.

20. The method according to claim 19, wherein determining the target loss value of the target loss function based on the plurality of encoding vectors, the category prediction values of the plurality of sample audios and the category labels of the plurality of sample audios comprises:
determining a predetermined sample set based on the plurality of sample audios, and constructing a plurality of training sample groups based on the predetermined sample set, each training sample group comprising an anchor sample, a positive sample and a negative sample, wherein the anchor sample is any sample audio in the predetermined sample set, the positive sample is the sample audio in the predetermined sample set, which is of the same category as the anchor sample, the negative sample is the sample audio in the predetermined sample set, which is not of the same category as the anchor sample;
determining a first loss value of a first loss function based on the encoding vectors corresponding to samples comprised in each of the training sample groups, the first loss function being used to reflect a difference between the encoding vector of the anchor sample and the encoding vector of the positive sample, and a difference between the encoding vector of the anchor sample and the encoding vector of the negative sample, and determining a second loss value of a second loss function based on differences between the category prediction values of the plurality of sample audios and the category labels of the plurality of sample audios; and
determining the target loss value of the target loss function based on the first loss value of the first loss function and the second loss value of the second loss function.

21. The method according to claim 19, wherein the feature encoding model comprises an encoding network, and encoding the audio features of the plurality of sample audios by the feature encoding model to obtain the plurality of encoding vectors of the plurality of sample audios comprises:
encoding the audio features of the plurality of sample audios according to the encoding network to obtain the plurality of encoding vectors of the plurality of sample audios, the encoding network comprising a residual network or a convolutional network, wherein an encoding vector output by the encoding network of the trained feature encoding model is usable as a feature vector of an audio output by the feature encoding model.

22. The method according to claim 21, wherein the residual network comprises at least one of an instance normalization (IN) layer and a batch normalization (BN) layer.

23. The method according to claim 21, wherein the encoding network further comprises a GeM pooling layer, and encoding the audio features of the plurality of sample audios according to the encoding network to obtain the plurality of encoding vectors of the plurality of sample audios comprises:
encoding the audio features of the plurality of sample audios according to the residual network or the convolutional network to obtain a plurality of initial encoding vectors of the plurality of sample audios; and
processing the plurality of initial encoding vectors according to the GeM pooling layer to obtain the plurality of encoding vectors of the plurality of sample audios.

24. The method according to claim 19, wherein the feature encoding model comprises a BN layer and a classification layer, and the method further comprises:
processing the plurality of encoding vectors according to the BN layer to obtain a plurality of regularized encoding vectors; and
performing classification processing on the plurality of sample audios based on the plurality of encoding vectors to obtain the category prediction values of the plurality of sample audios comprises:
performing classification processing on the plurality of regularized encoding vectors according to the classification layer to obtain the category prediction values of the plurality of sample audios, wherein an encoding vector output from the BN layer of the trained feature encoding model is usable as a feature vector of an audio output by the feature encoding model.

25. The method according to claim 19, wherein the audio features of the plurality of sample audios comprises at least of:
a spectrum feature,
a Mel-spectrum feature,
a spectrogram feature, and
a constant-Q transform (CQT) feature.

26. An electronic device, comprising:
a storage device storing at least one computer program thereon; and
at least one processing device being used to execute the at least one computer program in the storage device to implement acts comprising:
acquiring a plurality of sample audios marked with category labels;
extracting audio features of the plurality of sample audios;
encoding the audio features of the plurality of sample audios by a feature encoding model to obtain a plurality of encoding vectors of the plurality of sample audios, and performing classification processing on the plurality of sample audios based on the plurality of encoding vectors to obtain category prediction values of the plurality of sample audios; and
determining a target loss value of a target loss function based on the plurality of encoding vectors, the category prediction values of the plurality of sample audios and the category labels of the plurality of sample audios, and updating a parameter of the feature encoding model based on the target loss value to reduce a difference between the encoding vectors of the sample audios of a same category, to increase a difference between the encoding vectors of the sample audios of different categories, and to reduce a difference between the category prediction values and the category labels of the plurality of sample audios, so as to obtain the trained feature encoding model.

27. The device according to claim 26, wherein determining the target loss value of the target loss function based on the plurality of encoding vectors, the category prediction values of the plurality of sample audios and the category labels of the plurality of sample audios comprises:
determining a predetermined sample set based on the plurality of sample audios, and constructing a plurality of training sample groups based on the predetermined sample set, each training sample group comprising an anchor sample, a positive sample and a negative sample, wherein the anchor sample is any sample audio in the predetermined sample set, the positive sample is the sample audio in the predetermined sample set, which is of the same category as the anchor sample, the negative sample is the sample audio in the predetermined sample set, which is not of the same category as the anchor sample;
determining a first loss value of a first loss function based on the encoding vectors corresponding to samples comprised in each of the training sample groups, the first loss function being used to reflect a difference between the encoding vector of the anchor sample and the encoding vector of the positive sample, and a difference between the encoding vector of the anchor sample and the encoding vector of the negative sample, and determining a second loss value of a second loss function based on differences between the category prediction values of the plurality of sample audios and the category labels of the plurality of sample audios; and
determining the target loss value of the target loss function based on the first loss value of the first loss function and the second loss value of the second loss function.

28. The device according to claim 26, wherein the feature encoding model comprises an encoding network, and encoding the audio features of the plurality of sample audios by the feature encoding model to obtain the plurality of encoding vectors of the plurality of sample audios comprises:
encoding the audio features of the plurality of sample audios according to the encoding network to obtain the plurality of encoding vectors of the plurality of sample audios, the encoding network comprising a residual network or a convolutional network, wherein an encoding vector output by the encoding network of the trained feature encoding model is usable as a feature vector of an audio output by the feature encoding model.

29. The device according to claim 28, wherein the residual network comprises at least one of an instance normalization (IN) layer and a batch normalization (BN) layer.

30. The device according to claim 28, wherein the encoding network further comprises a GeM pooling layer, and encoding the audio features of the plurality of sample audios according to the encoding network to obtain the plurality of encoding vectors of the plurality of sample audios comprises:
encoding the audio features of the plurality of sample audios according to the residual network or the convolutional network to obtain a plurality of initial encoding vectors of the plurality of sample audios; and
processing the plurality of initial encoding vectors according to the GeM pooling layer to obtain the plurality of encoding vectors of the plurality of sample audios.

31. The device according to claim 26, wherein the feature encoding model comprises a BN layer and a classification layer, and the acts further comprise:
processing the plurality of encoding vectors according to the BN layer to obtain a plurality of regularized encoding vectors; and
performing classification processing on the plurality of sample audios based on the plurality of encoding vectors to obtain the category prediction values of the plurality of sample audios comprises:
performing classification processing on the plurality of regularized encoding vectors according to the classification layer to obtain the category prediction values of the plurality of sample audios, wherein an encoding vector output from the BN layer of the trained feature encoding model is usable as a feature vector of an audio output by the feature encoding model.
